(19) United States
(12) Patent Application Publication
(10) Pub. No.: US 2026/0286649 A1
(43) Pub. Date: Sep. 24, 2026

(54) WORKING MACHINE

(71) Applicant: Yanmar Holdings Co., Ltd., Osaka (JP)

(72) Inventor: Jun Terashima, Chikugo (JP)

(73) Assignee: Yanmar Holdings Co., Ltd., Osaka (JP)

(21) Appl. No.: 19/533,032

(22) Filed: Feb. 6, 2026

(30) Foreign Application Priority Data
Mar. 21, 2025 (JP) 2025-046358

(51) Int. Cl. E02F 9/08; B60L 50/60; B60L 58/26; E02F 9/02; E02F 9/12

(52) U.S. Cl. CPC E02F 9/0866; B60L 50/60; B60L 58/26; E02F 9/02; E02F 9/121; B60L 2200/40

(57) ABSTRACT

A working machine includes a turning support part. The turning support part turnably supports with respect to a lower traveling body an upper turning body disposed above the lower traveling body. The turning support part includes a slip ring and a rotary joint. The slip ring is connected to a first electric circuit of the upper turning body and a second electric circuit of the lower traveling body. The rotary joint is connected to a first cooling circuit of the upper turning body and a second cooling circuit of the lower traveling body.

### CROSS-REFERENCE

This application claims foreign priority of JP2025-046358 filed Mar. 21, 2025, the disclosures of which is hereby incorporated by reference in its entirety.

### TECHNICAL FIELD

The present invention relates to a working machine.

### BACKGROUND ART

Conventionally, there has been known a working machine in which a lower traveling body turnably supports an upper turning body. For example, a construction machine of Patent Literature 1 includes an electrified motor for turning the upper turning body with respect to the lower traveling body, and an electrified motor for traveling mounted on the lower traveling body. Hence, the working machine of Patent Literature 1 includes inverters that are mounted not only on the upper turning body but also on the lower traveling body.

### PRIOR ART DOCUMENT

### Patent Document

Patent Document 1: JP-A-2014-163190

### SUMMARY OF INVENTION

### Technical Problem

However, it is difficult to sufficiently cool power electronics devices such as inverters by natural air cooling. Particularly when work is performed in a traveling stop state, the inverter mounted on a lower traveling body is not sufficiently cooled by natural air cooling. Therefore, it is concerned that the power electronics devices of the lower traveling body cannot maintain a continuous output.

On the other hand, by attaching to the lower traveling body a cooling circuit in which a refrigerant has been circulated and cooling the power electronics devices using the cooling circuit, the power electronics devices of the lower traveling body can maintain a continuous output. In this regard, it is difficult to secure in the lower traveling body a space for disposing a radiator for cooling the circulating refrigerant.

In view of the above circumstances, an object of the present invention is to cool power electronics devices of a lower traveling body without disposing a radiator in the lower traveling body.

### Solution to Problem

To achieve the above object, in a working machine according to one aspect of the present invention, an upper turning body is disposed above a lower traveling body. The working machine includes a turning support part. The turning support part turnably supports the upper turning body with respect to the lower traveling body. The turning support part includes a slip ring and a rotary joint. The slip ring connects and conducts a first electric circuit of the upper turning body and a second electric circuit of the lower traveling body. The rotary joint connects a first cooling circuit of the upper turning body and a second cooling circuit of the lower traveling body to enable a refrigerant to circulate between the first cooling circuit and the second cooling circuit.

Further features and advantages of the present invention will become more apparent from the following embodiment.

### ADVANTAGEOUS EFFECTS OF INVENTION

According to the present invention, it is possible to cool power electronics devices of a lower traveling body without disposing a radiator in the lower traveling body.

### BRIEF DESCRIPTION OF DRAWINGS

FIG. 1 is a schematic side view showing a configuration example of a hydraulic excavator according to an embodiment; and

FIG. 2 is a block diagram schematically showing the configuration example of the hydraulic excavator.

### DESCRIPTION OF EMBODIMENTS

Hereinafter, an embodiment of the present invention will be described with reference to the drawings.

Note that directions in the present disclosure are defined as follows. First, in an upper turning body 1, a direction from one of a front side and a back side of an operator's seat 111 to be described later on which an operator (an operating person or a driver) sits toward the other is defined as a “front-rear direction”. In the “front-rear direction”, a direction from the back side to the front side of the operator's seat 111 is a “front side”, and a direction from the front side to the back side of the operator's seat 111 is a “rear side”. Therefore, in a state where the upper turning body 1 is not turning with respect to the lower traveling body 2 (turning angle: 0°), the front-rear direction of the upper turning body 1 coincides with a direction in which the lower traveling body 2 moves forward and rearward.

Furthermore, in a state where the front is viewed from the rear side, a direction from one of a left side and a right side of the operator's seat 111 toward the other is a “left-right direction”. In the left-right direction, a direction toward the left side of the operator's seat 111 is a “left side”, and a direction toward the right side of the operator's seat 111 is a “right side”.

Furthermore, a direction from one of the lower traveling body 2 and the upper turning body 1 toward the other is an “up-down direction”. In the up-down direction, a direction from the lower traveling body 2 to the upper turning body 1 is “upward”, and a direction from the upper turning body 1 to the lower traveling body 2 is “downward”. Accordingly, when a hydraulic excavator 100 is disposed on a horizontal plane whose vertical direction is the normal direction, the up-down direction of the hydraulic excavator 100 coincides with the up-down direction. Furthermore, the upper side coincides with the vertically upper side, and the lower side coincides with the vertically lower side.

The front-rear direction, the left-right direction, and the up-down direction are perpendicular to each other. Note that the definitions of these directions are merely used for description, and are not intended to limit the actual positional relationships and directions.

### 1. Hydraulic Excavator 100

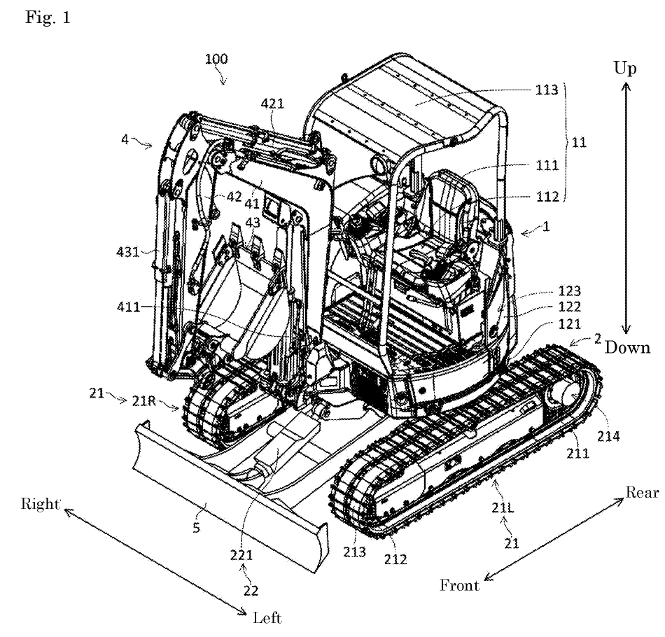

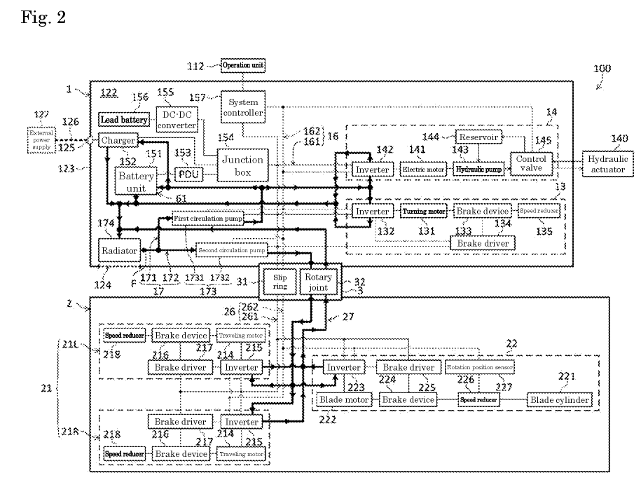

FIG. 1 is a schematic side view showing a configuration example of the hydraulic excavator 100 according to the present embodiment. FIG. 2 is a block diagram schematically showing a configuration example of the hydraulic excavator 100. Note that the hydraulic excavator 100 is an example of a “working machine” of the present invention.

The hydraulic excavator 100 includes the upper turning body 1, the lower traveling body 2, a turning support part 3, a working machine 4, and a blade 5. Note that, in the present embodiment, the upper turning body 1 (a portion constituting an engine room 122 to be described later in particular) may be collectively referred to as a “machine body”.

The upper turning body 1 is disposed above the lower traveling body 2, and is turnable with respect to the lower traveling body 2 with the turning support part 3 interposed therebetween. The turning support part 3 is disposed between the upper turning body 1 and the lower traveling body 2 in the up-down direction, and turnably supports the upper turning body 1 with respect to the lower traveling body 2.

The working machine 4 is disposed on the front side of the upper turning body 1, and performs excavation work of earth, sand, and the like. The working machine 4 includes a boom 41, an arm 42, and a bucket 43. By independently driving the boom 41, the arm 42, and the bucket 43, the working machine 4 can perform excavation work of earth, sand, and the like. The boom 41 is rotated by a boom cylinder 411. A base end part of the boom cylinder 411 is supported by a front part of a machine body frame 121 and is movable so as to be capable of freely extending and contracting. The arm 42 is rotated by an arm cylinder 421. A base end part of the arm cylinder 421 is supported by the boom 41 and is movable so as to be capable of freely extending and contracting. The bucket 43 is rotated by a bucket cylinder 431. A base end part of the bucket cylinder 431 is supported by the arm 42, and is movable so as to be capable of freely extending and contracting. The boom cylinder 411, the arm cylinder 421, and the bucket cylinder 431 are configured with hydraulic cylinders.

The blade 5 is disposed on the front side of the lower traveling body 2, and performs leveling work and the like.

### 1-1. Upper Turning Body 1

The upper turning body 1 includes an operation part 11, the machine body frame 121, an engine room 122, and a hood 123.

The operation part 11 includes an operator's seat 111, an operation unit 112, and a canopy 113 (see FIG. 1). An operator sits on the operator's seat 111. The operation unit 112 accepts an operator’s operation, and outputs contents of the operation to a system controller 157 described later. The operation unit 112 includes various devices (such as an operation lever and a monitor) disposed around the operator's seat 111. In response to the operator’s operation on the operation unit 112, the hydraulic excavator 100 can perform turning of the upper turning body 1, traveling of the lower traveling body 2, excavation work of the working machine 4, leveling work of the blade 5, and the like. The canopy 113 is a hood that covers the operator's seat 111 and the operation unit 112 from the upper side, and is installed above the operator's seat 111 and the operation unit 112.

The machine body frame 121 is a base part of the machine body, and has a plate shape extending perpendicularly to the up-down direction. On the machine body frame 121, the operation part 11 is disposed, and various devices and the like housed in the engine room 122 are mounted. The engine room 122 is the inside of the machine body, and is positioned between the operation part 11 and the machine body frame 121 in the up-down direction. The hood 123 covers the engine room 122 together with a platform of the operation part 11, the machine body frame 121, and the like. A vent 124 and a power feeding port 125 are disposed in the hood 123 (see FIG. 2). The vent 124 connects the inside and the outside of the engine room 122. The power feeding port 125 can be connected to an external power supply 127 (e.g., commercial power grid) via, for example, a power feeding cable 126. Consequently, the hydraulic excavator 100 can charge a battery unit 151 and a lead battery 156 described later.

### 1-1-1. Turning Driving Unit 13

Furthermore, as illustrated in FIG. 2, the upper turning body 1 further includes the turning driving unit 13. The turning driving unit 13 is disposed inside the engine room 122 of the upper turning body 1. The turning driving unit 13 includes a turning motor 131, an inverter 132, a brake device 133, a brake driver 134, and a speed reducer 135. The turning motor 131 is an electric actuator, and generates a driving force for turning the upper turning body 1 with respect to the lower traveling body 2 and outputs the driving force to the speed reducer 135. The inverter 132 supplies electric power to the turning motor 131, and controls a rotational speed, a rotation direction, and the like of the turning motor 131 based on a control signal of the system controller 157. The brake device 133 suppresses or prevents transmission of the driving force from the turning motor 131 to the speed reducer 135 or suppresses or prevents output of the driving force of the turning motor 131, in response to the operator’s operation on the operation part 11 or the like. The brake driver 134 controls the brake device 133 based on a control signal of the system controller 157. The speed reducer 135 increases the driving force (rotational force) transmitted from the turning motor 131 by deceleration at a predetermined reduction ratio, and rotates by the driving force the upper turning body 1 about a rotary joint 32 that will be described later and extends in the up-down direction.

### 1-1-2. Hydraulic System Driving Unit 14

Furthermore, as illustrated in FIG. 2, the upper turning body 1 further includes the hydraulic system driving unit 14. The hydraulic system driving unit 14 is disposed inside the engine room 122 of the upper turning body 1, and outputs the driving force to a hydraulic actuator 140. Note that the hydraulic actuator 140 is a hydraulic driving device connected to the upper turning body 1, and includes, for example, the boom cylinder 411, the arm cylinder 421, the bucket cylinder 431, and the like.

The hydraulic system driving unit 14 includes an electric motor 141, an inverter 142, a hydraulic pump 143, a reservoir 144, and a control valve 145. The electric motor 141 drives the hydraulic pump 143 for driving the hydraulic actuator 140. The inverter 142 supplies electric power to the electric motor 141, and controls a rotational speed, a rotation direction, and the like of the electric motor 141 based on the control signal of the system controller 157. The hydraulic pump 143 is connected to an output shaft of the electric motor 141, and outputs the driving force (hydraulic pressure) to the hydraulic actuator 140 via the control valve 145. The reservoir 144 is a hydraulic oil tank that houses (stores) a hydraulic oil, and supplies the hydraulic oil to the hydraulic pump 143 via a hydraulic hose. The control valve 145 is a direction switching valve that controls a flow direction, a flow rate, and the like of the hydraulic oil (pressure oil) to be supplied from the hydraulic pump 143 to the hydraulic actuator 140.

When driven by the electric motor 141, the hydraulic pump 143 compresses the hydraulic oil supplied from the reservoir 144 to a predetermined hydraulic pressure. The control valve 145 supplies the hydraulic oil (pressure oil) to the hydraulic actuator 140 based on the control signal of the system controller 157. Thus, the hydraulic actuator 140 is driven. Note that the hydraulic oil having circulated through the hydraulic actuator 140 is returned to the reservoir 144 by the control valve 145.

### 1-1-3. Devices Mounted On Upper Turning Body 1

Furthermore, the upper turning body 1 further includes a plurality of devices. The plurality of devices includes the battery unit 151, a charger 152, a Power Distribution Unit (PDU) 153, a junction box 154, a DC-DC converter 155, the lead battery 156, the system controller 157, and the like. These components are disposed in the engine room 122 of the upper turning body 1.

The battery unit 151 is a chargeable/dischargeable secondary battery, and is, for example, a lithium ion battery. The battery unit 151 may be configured by unitizing a plurality of battery cells, or may be configured with a single battery cell.

The charger 152 is also called a power feeder, and converts an alternating current voltage supplied from the external power supply 127 via the power feeding cable 126 into a direct current voltage.

The PDU 153 is a battery control unit that controls an internal battery relay to control input/output of electric power in and from the battery unit 151.

The junction box 154 includes a charger relay, an inverter relay, a fuse, and the like. The electric power output from the above charger 152 is supplied to the battery unit 151 via the junction box 154 and the PDU 153. Furthermore, the electric power output from the battery unit 151 is supplied to the components of the hydraulic excavator 100 that need power supply via the PDU 153 and the junction box 154.

The DC-DC converter 155 steps down a direct current voltage of a high voltage (e.g., 300 V) supplied from the battery unit 151 via the junction box 154 to a low voltage (e.g., 12 V). The voltage output from the DC-DC converter 155 is supplied to the system controller 157 and the like similarly to the output from the lead battery 156.

The lead battery 156 outputs a direct current voltage of a low voltage (e.g., 12 V). The output from the lead battery 156 is supplied as a control voltage to, for example, the system controller 157 and the like.

The system controller 157 is a control device that controls the respective components of the hydraulic excavator 100, and includes an electronic control unit that is also called an ECU. The number of the system controllers 157 may be singular or may be plural.

### 1-1-4: Upper Electric Circuit 16

Next, the upper turning body 1 further includes the upper electric circuit 16. The upper electric circuit 16 is an example of a “first electric circuit” of the present invention, and is illustrated as a thin solid line in FIG. 2. The upper electric circuit 16 is an electric circuit (a wiring structure thereof in particular) disposed in the upper turning body 1. The upper electric circuit 16 includes an upper feed line 161 and an upper signal transmission circuit 162.

The upper feed line 161 inputs and outputs electric power to and from various electric devices mounted on the upper turning body 1, and supplies electric power to the lower traveling body 2 via a slip ring 31 of the turning support part 3 described later. The upper feed line 161 includes a high voltage path, a low voltage path, and the like. The high voltage path (a reference numeral is omitted) is a wiring through which direct current electric power of a high voltage (e.g., 300 V) flows. The high voltage path is connected to the power electronics devices mounted on the upper turning body 1, and transmits and receives direct current electric power of the high voltage to and from the power electronics devices. The power electronics devices include, for example, the battery unit 151 and the inverters 132 and 142. The low voltage path (a reference numeral is omitted) is a wiring through which direct current electric power of a low voltage (e.g., 12 V) flows. The low voltage path is connected with the inverters 132 and 142, the brake driver 134, the DC-DC converter 155, the lead battery 156, a circulation pump 173, and the like. The low voltage path supplies direct current electric power of the low voltage to these components. Note that, in FIG. 2, the high voltage path and the low voltage path are not distinguished for ease of illustration of the configuration, and are illustrated as the upper feed line 161.

The upper signal transmission circuit 162 is illustrated as a thin and fine broken line in FIG. 2. The upper signal transmission circuit 162 transmits electric signals (such as a control signal and a detection signal) transmitted and received between the electric devices mounted on the upper turning body 1, and transmits and receives electric signals between the electric devices (the system controller 157 in particular) and the lower traveling body 2 via the slip ring 31. Note that FIG. 2 illustrates the main upper signal transmission circuit 162 for ease of illustration of the configuration.

### 1-1-5. Upper Cooling Circuit 17

Furthermore, the upper turning body 1 further includes the upper cooling circuit 17. The upper cooling circuit 17 is an example of a “first cooling circuit” of the present invention, and is illustrated as a thick solid line in FIG. 2. The upper cooling circuit 17 is a flow circuit (a flow path structure thereof in particular) of a refrigerant F disposed in the upper turning body 1. For example, the upper cooling circuit 17 includes a first cooling path 171, a second cooling path 172, the circulation pump 173, and a radiator 174.

The first cooling path 171 is a flow path for circulating the refrigerant F to the electric devices mounted on the upper turning body 1, and cools the electric devices using the refrigerant F. The second cooling path 172 is a flow path for circulating the refrigerant F to a lower cooling circuit 27 of the lower traveling body 2 described later, and is connected to the lower cooling circuit 27 with the rotary joint 32 interposed therebetween. The refrigerant F is water for cooling in the present embodiment, but is not limited to this example, and may be a liquid for cooling (such as a fluid containing an antifreeze liquid) other than water, or may be a gas for cooling such as a non-fluorocarbon gas.

Note that the number of flow paths for the refrigerant F included in the upper cooling circuit 17 is two in the present embodiment, but is not limited to this example, and may be three or more. Furthermore, the above example does not exclude a configuration where the number of flow paths for the refrigerant F included in the upper cooling circuit 17 is singular.

Furthermore, in the present embodiment, the first cooling path 171 and the second cooling path 172 are connected with the radiator 174 interposed therebetween, that is, share the radiator 174. In this regard, this example does not exclude a configuration where the first cooling path 171 and the second cooling path 172 are not connected with the radiator 174 interposed therebetween. In a case where, for example, a plurality of the radiators 174 are disposed, a part of the flow paths for the refrigerant F included in the upper cooling circuit 17 may be connected to the radiator 174 different from that of the other part of the flow paths.

The circulation pump 173 is mounted on the upper turning body 1 and circulates the refrigerant F. For example, the circulation pump 173 is connected to the upper cooling circuit 17, and circulates the refrigerant F flowing through the upper cooling circuit 17. Note that, as described later, the refrigerant F circulated by the circulation pump 173 includes the refrigerant F circulating through the lower cooling circuit 27 via the upper cooling circuit 17 and the rotary joint 32. The circulation pump 173 is controlled by the system controller 157.

As illustrated in FIG. 2, the circulation pump 173 includes a first circulation pump 1731 and a second circulation pump 1732. Note that some or all of the pumps such as the first circulation pump 1731 and the second circulation pump 1732 included in the circulation pump 173 may be simply referred to as the “circulation pump 173”.

The first circulation pump 1731 is controlled by the system controller 157 to circulate the refrigerant F to the electric devices mounted on the upper turning body 1. For example, the first circulation pump 1731 is connected to the first cooling path 171, and supplies the cooled refrigerant F supplied from the radiator 174, to components that are mounted on the upper turning body 1 and need to be cooled by the refrigerant F. Particularly, the first circulation pump 1731 supplies the refrigerant F to the power electronics devices (e.g., the battery unit 151 and the inverters 132 and 142), the PDU 153, and the like.

The second circulation pump 1732 is controlled by the system controller 157 to circulate the refrigerant F to the lower cooling circuit 27 via the rotary joint 32. For example, the second circulation pump 1732 is connected to the second cooling path 172, and supplies the cooled refrigerant F supplied from the radiator 174, to (the lower cooling circuit 27 of) the lower traveling body 2 via the rotary joint 32.

Thus, both of the first circulation pump 1731 and the second circulation pump 1732 are disposed in the upper turning body 1. By so doing, it is possible to mount the first circulation pump 1731 and the second circulation pump 1732 in a safe space in the upper turning body 1 in the hydraulic excavator 100. Note that the refrigerant F having finished circulating through the first cooling path 171 and the second cooling path 172 (and the lower cooling circuit 27) returns to the radiator 174.

Furthermore, by disposing the first circulation pump 1731 and the second circulation pump 1732, the hydraulic excavator 100 can control cooling by the refrigerant F on the upper turning body 1 side and the lower traveling body 2 side at a necessary rate, that is, can control a supply amount of the refrigerant F to each of the upper turning body 1 side and the lower traveling body 2 side at the above-described rate.

More specifically, the flow rate (per unit time) of the refrigerant F flowing from the radiator 174 to the first cooling path 171, and the flow rate (per unit time) of the refrigerant F flowing from the radiator 174 to the second cooling path 172 are determined according to a ratio between a drive amount of the first circulation pump 1731 and a drive amount of the second circulation pump 1732. Note that the “drive amount” described here means the flow rate of the refrigerant F per unit time. The system controller 157 drives both of the first circulation pump 1731 and the second circulation pump 1732 at a ratio matching the operation on the operation part 11 (in other words, an operation status of the hydraulic excavator 100).

Here, when the hydraulic excavator 100 travels on a slope or the like, a load to be applied to the devices mounted on the lower traveling body 2 is larger than a load to be applied to the devices mounted on the upper turning body 1. At this time, the system controller 157 makes the drive amount of the second circulation pump 1732 larger than the drive amount of the first circulation pump 1731. That is, the system controller 157 makes a flow rate of the refrigerant flowing from the radiator 174 to the second cooling path 2 larger than a flow rate of the refrigerant flowing to the first cooling path 1. By so doing, the cooled refrigerant F supplied from the radiator 174 is preferentially supplied to the lower cooling circuit 27 via the second cooling path 172 and the rotary joint 32. Accordingly, the hydraulic excavator 100 can effectively cool the devices (such as the inverters 215 of traveling parts 21) of the lower traveling body 2 that generate heat as a load during traveling increases while keeping cooling the battery unit 151 that is a power source. Consequently, the hydraulic excavator 100 can suppress or prevent deterioration in traveling performance.

Furthermore, when the hydraulic excavator 100 performs work using the working machine 4 in a state where the hydraulic excavator 100 stops, a load to be applied to the devices mounted on the upper turning body 1 is larger than a load to be applied to the devices mounted on the lower traveling body 2. At this time, the system controller 157 makes the drive amount of the first circulation pump 1731 larger than the drive amount of the second circulation pump 1732. That is, the system controller 157 makes the flow rate of the refrigerant flowing from the radiator 174 to the first cooling path 1 larger than the flow rate of the refrigerant flowing to the second cooling path 2. Alternatively, when the load applied to the devices mounted on the lower traveling body 2 is small and cooling is unnecessary as described above, the system controller 157 may stop driving the second circulation pump 1732 and stop supplying the refrigerant to the lower cooling circuit 27. By so doing, the cooled refrigerant F supplied from the radiator 174 is preferentially supplied to the first cooling path 171. Accordingly, the hydraulic excavator 100 can effectively cool the devices (such as the inverters 132 and 142) mounted on the upper turning body 1 that generates heat as the load required to drive the working machine 4 or the like increases while keeping cooling the battery unit 151 that is the power source. Consequently, the hydraulic excavator 100 can suppress or prevent deterioration in workability of the working machine 4 and the like.

Furthermore, when the hydraulic excavator 100 performs work using the working machine 4 in a state where the hydraulic excavator 100 is moving or stops on a slope or the like, the same load may be applied to the devices mounted on the upper turning body 1 and the devices mounted on the lower traveling body 2. At this time, the system controller 157 sets the drive amount of the first circulation pump 1731 and the drive amount of the second circulation pump 1732 to substantially the same amount. That is, the system controller 157 makes the flow rate of the refrigerant F flowing from the radiator 174 to the first cooling path 1 the same as the flow rate of the refrigerant F flowing to the second cooling path 2. By so doing, the cooled refrigerant F supplied from the radiator 174 is supplied to the first cooling path 171 and the second cooling path 172 in a well-balanced manner. Accordingly, the hydraulic excavator 100 can cool the devices mounted on the upper turning body 1 and the devices mounted on the lower traveling body 2 in a well-balanced manner while keeping cooling the battery unit 151 that is the power source. Consequently, the hydraulic excavator 100 can suppress or prevent deterioration of workability.

Note that the number of the circulation pumps 173 is two in the present embodiment, and the one circulation pump 173 is disposed in each of the cooling paths 171 and 172. In this regard, the present invention is not limited to this example, and the number of the circulation pumps 173 disposed in the machine body of the upper turning body 1 may be three or more. Furthermore, the example of the present embodiment does not exclude a configuration where the number of the circulation pumps 173 is singular. In this case, for example, the ratio between the supply amount of the refrigerant F from the radiator 174 to the first cooling path 171 and the supply amount of the refrigerant F from the radiator 174 to the second cooling path 172 may be controlled by other than driving of the circulation pump 173, and may be controlled by, for example, arrangement of a distribution valve and driving control thereof.

Furthermore, the upper cooling circuit 17 (the first cooling path 171 in particular) passes through the inside of at least one of the electric device to which electric power is input and output via the upper electric circuit 16, and the battery unit 151. In the present embodiment, the upper cooling circuit 17 (the first cooling path 171 in particular) passes through the inside of the battery unit 151, the PDU 153, and the inverters 132 and 142. By so doing, heat dissipation to the refrigerant F flowing through the upper cooling circuit 17 can cool electric devices (such as the PDU 153) that receive an input of and output electric power, and power electronics devices such as the battery unit 151 and the inverters 132 and 142.

Note that, preferably, the refrigerant F is supplied in parallel from the first circulation pump 1731 to each power electronics device, the PDU 153, and the like. However, this example does not exclude a configuration where the refrigerant F is supplied in series in at least some devices mounted on the upper turning body 1.

Furthermore, the second circulation pump 1732 circulates the refrigerant F to the lower traveling body 2 via the rotary joint 32 of the turning support part 3.

Note that the refrigerant F having performed thermal exchange with the components (the power electronics devices in particular) of the upper turning body 1 and the lower traveling body 2 circulates back to the radiator 174.

By so doing, the circulation pump 173 can circulate to the radiator 174 not only the refrigerant F flowing through the upper cooling circuit 17, but also the refrigerant F flowing through (the lower cooling circuit 27 of) the lower traveling body 2 connected to the upper cooling circuit 17 with the rotary joint 32 interposed therebetween. That is, it is not necessary to dispose the circulation pump 173 in the lower traveling body 2. Accordingly, the circulation pump 173 can be disposed in the safe space in the upper turning body 1 in the hydraulic excavator 100.

The radiator 174 is mounted on the upper turning body 1, and cools the refrigerant F having performed thermal exchange with the components (the power electronics devices in particular) of the upper turning body 1 and the lower traveling body 2. For example, the radiator 174 is connected to the upper cooling circuit 17, and cools the refrigerant F flowing through the upper cooling circuit 17. Note that, as described later, the refrigerant F to be cooled by the radiator 174 includes the refrigerant F that returns from the lower cooling circuit 27 to the upper cooling circuit 17 after circulating through the lower cooling circuit 27. Furthermore, the number of the radiators 174 is singular in the present embodiment, but is not limited to this example, and may be plural. By mounting the radiator 174 on the upper turning body 1, the hydraulic excavator 100 can cool not only the refrigerant F having flown through the upper cooling circuit 17, but also the refrigerant F having flown through the lower cooling circuit 27 connected to the upper cooling circuit 17 with the rotary joint 32 interposed therebetween using the radiator 174 mounted on the upper turning body 1. That is, it is not necessary to dispose the radiator 174 in the lower traveling body 2. Accordingly, it is possible to dispose the radiator 174 in the space capable of safely and sufficiently dissipating heat in the upper turning body 1 in the hydraulic excavator 100.

Preferably, the radiator 174 is disposed in the vicinity of the vent 124 of the hood 123 (see, for example, FIG. 2). More preferably, a fan for air cooling is disposed in the vicinity of the radiator 174 (e.g., between the radiator 174 and the vent 124). By so doing, the radiator 174 can efficiently dissipate heat from the refrigerant F. Accordingly, the radiator 174 can efficiently cool the refrigerant F.

### 1-2. Lower Traveling Body 2

The lower traveling body 2 includes the pair of left and right traveling parts 21 and a blade driving unit 22 (see FIG. 2). The pair of left and right traveling parts 21 enable the hydraulic excavator 100 to travel. The blade driving unit 22 drives the blade 5, and rotates the blade 5 in the up-down direction with respect to the lower traveling body 2, for example.

Hereinafter, the traveling part 21 on the left side may be referred to as a “traveling part 21L”, and the traveling part 21 on the right side may be referred to as a “traveling part 21R”. Each of the traveling parts 21L and 21R employs the same configuration except that the traveling parts 21L and 21R are symmetrical. Furthermore, at least one of the traveling parts 21L and 21R may be simply referred to as the “traveling part 21”.

### 1-2-1. Traveling Part 21

As illustrated in FIG. 1, the traveling part 21 includes a sprocket 211, an idler 212, and a crawler 213. The sprocket 211 is a drive wheel rotatably disposed on the rear side of the traveling part 21. The sprocket 211 has a gear shape and rotationally moves the crawler 213. The idler 212 is an idler wheel rotatably disposed on the front side of the traveling part 21, and guides the rotational movement of the crawler 213. The crawler 213 is an annular crawler belt, and is stretched across the sprocket 211 and the idler 212. On an inner surface of the crawler 213, a plurality of protrusions aligned in a rotation direction are disposed. The protrusions mesh with teeth of the sprocket 211. Thus, the crawler 213 rotationally moves seemlessly in response to rotation of the sprocket 211. When the crawlers 213 in the traveling parts 21L and 21R cooperate or independently rotate and move, the hydraulic excavator 100 can move forward or backward or turn right or left.

Furthermore, as illustrated in FIG. 2, the traveling part 21 further includes a traveling motor 214, an inverter 215, a brake device 216, a brake driver 217, and a speed reducer 218. The traveling motor 214 is an electric actuator that is a drive source of the traveling part 21. The traveling motor 214 outputs a driving force (rotational force) to the sprocket 211 via the speed reducer 218 to rotate the sprocket 211. The inverter 215 supplies electric power to the traveling motor 214, and controls a rotational speed, a rotation direction, and the like of the traveling motor 214 based on the control signal of the system controller 157. The brake device 216 suppresses or prevents transmission of the driving force from the traveling motor 214 to the speed reducer 218 or suppresses or prevents rotational driving of the speed reducer 218 in response to the operator’s operation on the operation part 11 or the like. The brake driver 217 controls the brake device 216 based on the control signal of the system controller 157. The speed reducer 218 increases the driving force (rotational force) transmitted from the traveling motor 214 by deceleration at a predetermined reduction ratio, and outputs the driving force to the sprocket 211.

### 1-2-2. Blade Driving Unit 22

Next, as illustrated in FIG. 2, the blade driving unit 22 includes a blade cylinder 221, a blade motor 222, an inverter 223, a brake device 224, a brake driver 225, a speed reducer 226, and a rotational position sensor 227. The blade cylinder 221 is an electric actuator that can expand and contract, and rotates the blade 5 in the up-down direction in response to the expansion and contraction operation. The blade motor 222 is an electric actuator, and outputs a driving force to the blade cylinder 221 via the speed reducer 226. The inverter 223 supplies electric power to the blade motor 222, and controls a rotational speed, a rotation direction, and the like of the blade motor 222 based on the control signal of the system controller 157. The brake device 224 suppresses or prevents transmission of the driving force from the blade motor 222 to the speed reducer 226 or suppresses or prevents output of the driving force of the blade motor 222, in response to the operator’s operation on the operation part 11 or the like. The brake driver 225 controls the brake device 224 based on the control signal of the system controller 157. The speed reducer 226 increases the driving force (rotational force) transmitted from the blade motor 222 by deceleration at a predetermined reduction ratio, and outputs the driving force to the blade cylinder 221. The rotational position sensor 227 is, for example, a resolver, and detects a rotational speed, a rotational direction, and the like of an output shaft of the speed reducer 226, and outputs the rotational speed, the rotational direction, and the like to the system controller 157.

### 1-2-3. Lower Electric Circuit 26

Next, the lower traveling body 2 further includes the lower electric circuit 26. The lower electric circuit 26 is an example of a “second electric circuit” of the present invention, and is illustrated as a thin solid line in FIG. 2. The lower electric circuit 26 is an electric circuit (a wiring structure thereof in particular) disposed in the lower traveling body 2. The lower electric circuit 26 connects the slip ring 31 and various electric devices mounted on the lower traveling body 2, supplies electric power to the electric devices, and transmits and receives electric signals. The lower electric circuit 26 includes a lower feed line 261 and a lower signal transmission circuit 262.

The lower feed line 261 supplies electric power supplied from the upper turning body 1 via the slip ring 31 to the components that are mounted on the lower traveling body 2 and require electric power. The lower feed line 261 includes a high voltage path, a low voltage path, and the like. The high voltage path (a reference sign is omitted) is a wiring that supplies direct current electric power of a high voltage (e.g., 300 V) supplied from the upper turning body 1 via the slip ring 31, and supplies electric power to the power electronics devices (e.g., inverters 215 and 223) mounted on the lower traveling body 2. The low voltage path (a reference sign is omitted) is a wiring that supplies direct current electric power of a low voltage (e.g., 12 V) supplied from the upper turning body 1 via the slip ring 31, and supplies electric power to the inverters 215 and 223, the brake drivers 217 and 225, and the like. In FIG. 2, the high voltage path and the low voltage path are not distinguished for ease of illustration of the configuration, and are illustrated as the lower feed line 261.

The lower signal transmission circuit 262 is illustrated as a thin and fine broken line in FIG. 2. The lower signal transmission circuit 262 transmits electric signals (such as a control signal and a detection signal) transmitted and received between the devices mounted on the lower traveling body 2, and transmits and receives electric signals between the devices (e.g., inverters 215 and 223) and the upper turning body 1 via the slip ring 31. Note that FIG. 2 illustrates the main lower signal transmission circuit 262 for ease of illustration of the configuration.

### 1-2-4. Lower Cooling Circuit 27

Furthermore, the lower traveling body 2 further includes the lower cooling circuit 27. The lower cooling circuit 27 is an example of a “second cooling circuit” of the present invention, and is illustrated as a thick solid line in FIG. 2. The lower cooling circuit 27 is a flow circuit (a flow path structure thereof in particular) of the refrigerant F disposed in the lower traveling body 2. The lower cooling circuit 27 supplies the refrigerant F supplied from (the second circulation pump 1732 of) the upper turning body 1 via the rotary joint 32 to the components that are mounted on the lower traveling body 2 and need to be cooled by the refrigerant F, and supplies the refrigerant F in particular to the power electronics devices (e.g., inverters 215 and 223). Note that the refrigerant F having performed thermal exchange with the components of the lower traveling body 2 (the power electronics devices in particular) circulates back to the radiator 174 of the upper turning body 1 via the rotary joint 32.

For example, as described above, the hydraulic excavator 100 includes the inverters 215 and 223 that are disposed in the lower traveling body 2 and supply electric power output from the lower electric circuit 26 to the electric actuators (e.g., the traveling motor 214 and the blade motor 222). The lower cooling circuit 27 passes through the inside of the above-described inverters 215 and 223. By so doing, heat dissipation to the refrigerant F cooled by the radiator 174 mounted on the upper turning body 1 and flowing through the lower cooling circuit 27 of the lower traveling body 2 can cool the inverters 215 and 223 mounted on the lower traveling body 2.

The above-described electric actuator includes the traveling motor 214 that is disposed in the lower traveling body 2 and drives the sprocket 211. By so doing, the hydraulic excavator 100 can supply electric power from the battery unit 151 mounted on the upper turning body 1 to the traveling motor 214 of the lower traveling body 2 without disposing a power source in the lower traveling body 2.

Note that, preferably, the refrigerant F is supplied in parallel from the rotary joint 32 to each power electronics device. In this regard, this example does not exclude a configuration where the refrigerant F is supplied in series in some power electronics devices.

### 1-3. Turning Support Part 3

The turning support part 3 turnably supports the upper turning body 1 with respect to the lower traveling body 2. Furthermore, the turning support part 3 enables transmission and reception of electric power and electric signals between the upper turning body 1 and the lower traveling body 2. Furthermore, the turning support part 3 enables the refrigerant F to circulate between the upper turning body 1 and the lower traveling body 2. The turning support part 3 includes the slip ring 31 and the rotary joint 32.

The slip ring 31 connects the upper electric circuit 16 of the upper turning body 1 and the lower electric circuit 26 of the lower traveling body 2. The slip ring 31 enables power supply from the upper turning body 1 side to the lower traveling body 2 side and transmission and reception of electric signals between the upper turning body 1 and the lower traveling body 2. More specifically, the slip ring 31 connects the upper feed line 161 of the upper turning body 1 and the lower feed line 261 of the lower traveling body 2, and enables power supply from the upper turning body 1 side to the lower traveling body 2 side. That is, the slip ring 31 connects and conducts the high voltage path of the upper feed line 161 and the high voltage path of the lower feed line 261, and connects and conducts the low voltage path of the upper feed line 161 and the low voltage path of the lower feed line 261. Furthermore, the slip ring 31 connects the upper signal transmission circuit 162 of the upper turning body 1 and the lower signal transmission circuit 262 of the lower traveling body 2, and enables transmission and reception of electric signals between the upper turning body 1 and the lower traveling body 2.

The rotary joint 32 connects the upper cooling circuit 17 of the upper turning body 1 and the lower cooling circuit 27 of the lower traveling body 2, and enables the refrigerant F to circulate between the first cooling circuit 17 and the second cooling circuit 27. For example, the rotary joint 32 includes a feed pipe and a return pipe. The feed pipe and the return pipe maintain a flow of the refrigerant F between the upper cooling circuit 17 and the lower cooling circuit 27 irrespectively of a turning state of the upper turning body 1. The feed pipe feeds the refrigerant F from the upper cooling circuit 17 to the lower cooling circuit 27. The return pipe returns the refrigerant F from the lower cooling circuit 27 to the upper cooling circuit 17.

By so doing, the hydraulic excavator 100 can maintain conduction between the upper electric circuit 16 of the upper turning body 1 and the lower electric circuit 26 of the lower traveling body 2 using the slip ring 31 irrespectively of the turning state of the upper turning body 1 with respect to the lower traveling body 2. That is, the slip ring 31 can transmit electric power, an electric signal, and the like from one of the upper electric circuit 16 and the lower electric circuit 26 to the other. For example, the battery unit 151 mounted on the upper turning body 1 and connected to the upper electric circuit 16 can output supply electric power to the electric devices such as the inverters 215 and 223 mounted on the lower traveling body 2 via the upper electric circuit 16 and the slip ring 31. Furthermore, the system controller 157 mounted on the upper turning body 1 can transmit and receive electric signals to and from the electric devices such as the inverters 215 and 223 mounted on the lower traveling body 2 via the upper electric circuit 16, the slip ring 31, and the lower electric circuit 26. That is, the hydraulic excavator 100 can supply electric power to the electric devices (the power electronics devices in particular) of the lower traveling body 2 without disposing the battery unit 151 in the lower traveling body 2. Furthermore, the hydraulic excavator 100 can control the electric devices mounted on the lower traveling body 2 without disposing the control device such as the system controller 157 in the lower traveling body 2.

Furthermore, the hydraulic excavator 100 can maintain the flow of the refrigerant F between the upper cooling circuit 17 of the upper turning body 1 and the lower cooling circuit 27 of the lower traveling body 2, using the rotary joint 32 irrespectively of the turning state of the upper turning body 1 with respect to the lower traveling body 2. Accordingly, the radiator 174 mounted on the upper turning body 1 can also cool the refrigerant F of the lower cooling circuit 27 in addition to the refrigerant F flowing through the upper cooling circuit 17. That is, the hydraulic excavator 100 can cool the electric devices (the power electronics devices in particular) of the lower traveling body 2 using the refrigerant F without disposing the circulation pump 173 and the radiator 174 in the lower traveling body 2.

Accordingly, the hydraulic excavator 100 can sufficiently exhibit these performances while securing a degree of freedom in arrangement design of the devices such as the battery unit 151, the system controller 157, and the radiator 174.

For example, the battery unit 151 is mounted on the upper turning body 1 and connected to the upper electric circuit 16. Furthermore, the electric actuators (e.g., the traveling motor 214, the blade motor 222, and the like) connected to the lower electric circuit 26 are mounted on the lower traveling body 2. The hydraulic excavator 100 can supply electric power from the battery unit 151 mounted on the upper turning body 1 to the electric actuators mounted on the lower traveling body 2. That is, it is not necessary to dispose a power source in the lower traveling body 2. Accordingly, the hydraulic excavator 100 can sufficiently secure a mounting space for the battery unit 151 having large capacity and a large size.

### 2. Remarks

The embodiment of the present invention has been described above. Note that the above embodiment is an example, and it is understood by those skilled in the art that various modifications can be made to combinations of the respective components and the respective processes, and these modifications are also within the scope of the present invention.

### 3. Summary

Hereinafter, the embodiment described so far will be summarized.

For example, a working machine 100 disclosed herein is the working machine 100 in which an upper turning body 1 is disposed above a lower traveling body 2, and employs a configuration (first configuration) that includes a turning support part 3 that turnably supports the upper turning body 1 with respect to the lower traveling body 2, and in which the turning support part 3 includes

a slip ring 31 that connects a first electric circuit 16 of the upper turning body 1 and a second electric circuit 26 of the lower traveling body 2, and

a rotary joint 32 that connects a first cooling circuit 17 of the upper turning body 1 and a second cooling circuit 27 of the lower traveling body 2.

The working machine 100 employing the above first configuration may employ a configuration (second configuration) in which the upper turning body 1 includes a radiator 174 that is connected to the first cooling circuit 17 and cools a refrigerant F flowing through the first cooling circuit 17.

Furthermore, the working machine 100 employing the above first or second configuration may employ a configuration (third configuration) in which the upper turning body 1 further includes a circulation pump 173 that is connected to the first cooling circuit 17 and circulates a refrigerant F flowing through the first cooling circuit 17.

Furthermore, the working machine 100 employing the above third configuration may employ a configuration (fourth configuration) in which the circulation pump 173 includes a first circulation pump that circulates the refrigerant F to a device mounted on the upper turning body 1, and a second circulation pump that circulates the refrigerant F to the second cooling circuit.

Furthermore, the working machine 100 employing any one of the above first to fourth configurations may employ a configuration (fifth configuration) including: a battery unit 151 that is mounted on the upper turning body 1 and connected to the first electric circuit 16; and electric actuators 214 and 222 that are mounted on the lower traveling body 2 and connected to the second electric circuit 26.

Furthermore, the working machine 100 employing the above fifth configuration may employ a configuration (sixth configuration) that includes electric devices 132 and 142 to which electric power is input and output via the first electric circuit 16, and in which the first cooling circuit 17 passes through an inside of at least one of the electric devices 132 and 142 and the battery unit 151.

Furthermore, the working machine 100 employing the above fifth or sixth configuration may employ a configuration (seventh configuration) that includes

inverters 215 and 223 that are disposed in the lower traveling body 2 and supplies, to the electric actuators 214 and 222, electric power output from the second electric circuit 26, and in which the second cooling circuit 27 passes through an inside of the inverters 215 and 223.

Furthermore, the working machine 100 employing any one of the above fifth to seventh configurations may employ a configuration (eighth configuration) in which the electric actuators 214 and 222 each include an electric motor 141 that is disposed in the lower traveling body 2 and drives a drive wheel 211.

### INDUSTRIAL APPLICABILITY

The present invention is applicable to working machines such as construction machines and agricultural machines.

### LIST OF REFERENCE SIGNS

100 Hydraulic excavator (working machine)

1 Upper turning body

11 Operation part

111 Driver's seat

112 Operation unit

113 Canopy

121 Machine body frame

122 Engine room

123 Hood

124 Vent

125 Power feeding port

126 Power feeding cable

127 External power supply

13 Turning driving unit

131 Turning motor

132 Inverter

133 Brake device

134 Brake driver

135 Speed reducer

14 Hydraulic system driving unit

140 Hydraulic actuator

141 Electric motor

142 Inverter

143 Hydraulic pump

144 Reservoir

145 Control valve

151 Battery unit

152 Charger

153 PDU

154 Junction box

155 DC-DC converter

156 Lead battery

157 System controller

16 Upper electric circuit (first electric circuit)

161 Upper feed line

162 Upper signal transmission circuit

17 Upper cooling circuit (first cooling circuit)

171 First cooling path

172 Second cooling path

173 Circulation pump

1731 First circulation pump

1732 Second circulation pump

174 Radiator

2 Lower traveling body

21, 21L, 21R Traveling part

211 Sprocket (drive wheel)

212 Idler

213 Crawler

214 Traveling motor

215 Inverter

216 Brake device

217 Brake driver

218 Speed reducer

22 Blade driving unit

221 Blade cylinder

222 Blade motor

223 Inverter

224 Brake device

225 Brake driver

226 Speed reducer

227 Rotation position sensor

26 Lower electric circuit (second electric circuit)

261 Lower feed line

262 Lower signal transmission circuit

27 Lower cooling circuit (second cooling circuit)

3 Turning support part

31 Slip ring

32 Rotary joint

4 Working machine

41 Boom

411 Boom cylinder

42 Arm

421 Arm cylinder

43 Bucket

431 Bucket cylinder

5 Blade

F Refrigerant

1. A working machine in which an upper turning body is disposed above a lower traveling body, the working machine comprising a turning support part that turnably supports the upper turning body with respect to the lower traveling body,
wherein the turning support part includes
a slip ring that connects a first electric circuit of the upper turning body and a second electric circuit of the lower traveling body, and
a rotary joint that connects a first cooling circuit of the upper turning body and a second cooling circuit of the lower traveling body.

2. The working machine according to claim 1, wherein the upper turning body includes a radiator that is connected to the first cooling circuit and cools a refrigerant flowing through the first cooling circuit.

3. The working machine according to claim 1, wherein the upper turning body further includes a circulation pump that is connected to the first cooling circuit and circulates a refrigerant flowing through the first cooling circuit.

4. The working machine according to claim 3, wherein
the circulation pump includes
a first circulation pump that circulates the refrigerant to a device mounted on the upper turning body, and
a second circulation pump that circulates the refrigerant to the second cooling circuit via the rotary joint.

5. The working machine according to claim 1, further comprising:
a battery unit that is mounted on the upper turning body and connected to the first electric circuit; and
an electric actuator that is mounted on the lower traveling body and connected to the second electric circuit.

6. The working machine according to claim 5, further comprising an electric device to which electric power is input and output via the first electric circuit,
wherein the first cooling circuit passes through an inside of at least one of the electric device and the battery unit.

7. The working machine according to claim 5, further comprising an inverter that is disposed in the lower traveling body and supplies, to the electric actuator, electric power output from the second electric circuit,
wherein the second cooling circuit passes through an inside of the inverter.

8. The working machine according to claim 5, wherein the electric actuator includes an electric motor that is disposed in the lower traveling body and drives a drive wheel.
